(19) United States
(12) Patent Application Publication
(10) Pub. No.: US 2012/0278761 A1
(43) Pub. Date: Nov. 1, 2012

(54) METHOD AND SYSTEM FOR MANAGING DUPLICATE ITEM DISPLAY

(75) Inventor: Madhu John, Pune (IN)

(73) Assignee: SYMANTEC CORPORATION, Mountain View, CA (US)

(21) Appl. No.: 13/097,428

(22) Filed: Apr. 29, 2011

(51) Int. Cl. G06F 3/048

(52) U.S. Cl. 715/810

(57) ABSTRACT

A system and method for displaying items in a list includes displaying a representation of duplicate items within the list as a visual attribute, wherein the duplicate items include a common body portion. In response to user interaction with the visual attribute, the list is expanded, wherein the expanding causes the display of the duplicate items. In response to user interaction with the visual attribute, the list is collapsed, wherein the collapsing causes the removal of the display of the duplicate items.

### FIELD

Embodiments according to the present invention generally relate to computer systems, in particular to management of duplicate items within lists.

### BACKGROUND

Employees at companies, especially large companies, generate large amounts of electronic data every day. Data may include electronic mail messages (“email”), documents, programs, files, etc. Everything created, sent, and received by employees may be stored and archived by the company for potential future need. For example, during legal proceedings, the company may be required to produce information during discovery.

Simple acts by employees can quickly lead to a tremendous amount of data and duplicate data that need to be archived. For example, an employee may generate and send an email to a distribution list of twenty people. The company must then archive the sent email from the employee and the twenty duplicate emails in each recipients email box. If the email then initiates a back and forth discussion within the distribution list, a large amount of data can be quickly generated, and it all may need to be archived and later retrieved.

The company may need to access the archived data in the future. For example, the company may find itself involved with discovery related to legal proceedings. The company may be required to produce documents related to a specific event. An electronic search of the archives will then produce a list of documents that will then need to be individually reviewed by a reviewer.

The presence of duplicate items in any archive slows down the process of review. In most cases, the decision taken by the reviewer on one item of a set of duplicates is the same for all items in the set of duplicates. However, the reviewer must nevertheless go through all of the duplicate items one by one. The problem is compounded when there are large numbers of duplicate items in the list. The problem is especially crucial during the process of legal discovery where accidental exclusion of an item can result in serious legal consequences.

### SUMMARY

Embodiments of the present invention are directed to a method and system for managing the display of duplicate items in a list. A user may need to search archives and collect data. For example, a company may be involved with legal discovery. In order to comply with a discovery request, documents need to be provided. However, the documents must first be reviewed by a reviewer in order to ensure they are properly related to the request. The documents may be pulled from a company archive of collected data, and the collected data might include many item duplicates. Therefore the duplicate item display management system, in accordance with embodiments of the present invention, displays the duplicate items together under a header, e.g. stack head. The stack head may be expanded to display all of the duplicate items, or collapsed to display only the stack head.

In one embodiment, a method of displaying items in a list includes: displaying a representation of duplicate items within the list as a particular visual attribute or on-screen tool, wherein the duplicate items include a common body portion; in response to user interaction with the particular visual attribute, expanding the list, wherein the expanding causes the display of the duplicate items; and in response to user interaction with the particular visual attribute, collapsing the list, wherein the collapsing causes the removal of the display of the duplicate items.

In some embodiments the particular visual attribute is a visual representation selected from the group consisting of a file name, an electronic mail message subject line, an electronic mail message sender, and an electronic mail message recipient. In further embodiments, the visual attribute includes a chevron shaped tool that is a graphical user interface tool, the expanding is performed in response to user interaction with the chevron shaped tool, and the collapsing is performed in response to user interaction with the chevron shaped on-screen tool.

In various embodiments, the visual attribute or on-screen tool includes at least one of an icon, a name, a date, and a number representing the number of the duplicate items represented by the visual attribute. In some embodiments, the method of displaying items in a list includes displaying the list as a group view, wherein the visual attribute includes: an author; and a number representing the number of the duplicate items represented by the visual attribute.

In one embodiment, the method of displaying items in a list includes displaying the list as an expanded view, wherein the visual attribute includes: an author, a subject/filename, a date, a status, and a type. In another embodiment, the method of displaying items in a list includes in response to user interaction with the visual attribute, displaying a preview of the common body portion, and in response to user interaction with at least one of the duplicate items, displaying the preview of the common body portion.

In another embodiment, a method of on-screen management of items includes: graphically representing a plurality of duplicate items within a list as a single item; in response to user interaction with the single item, displaying the plurality of duplicate items next to the single item within the list; and in response to user interaction, displaying the plurality of duplicate items within the list as the single item.

In some embodiments the single item is a visual representation selected from the group consisting of a file name, an electronic mail message subject line, an electronic mail message sender, and an electronic mail message recipient. In further embodiments, the single item includes a chevron shaped on-screen tool, the displaying the plurality of duplicate items after the single item is performed in response to user interaction with the chevron shaped on-screen tool, and the displaying the plurality of duplicate items as the single item is performed in response to user interaction with the chevron shaped on-screen tool.

In various embodiments, the single item includes at least one of an icon, a name, a date, and a number representing the number of the plurality duplicate items. In some embodiments the method of displaying items in a list includes displaying the list as a group view, wherein the single item includes: an author; and a number representing the number of the plurality duplicate items represented by the single item.

In one embodiment, the method of displaying items in a list includes displaying the list as an expanded view, wherein the single item includes: an author, a subject/filename, a date, a status, and a type. In various embodiments, the method of displaying items in a list includes in response to user interaction with the single item, displaying a preview of the plurality of duplicate items.

In another embodiment, a system is described including: a processor; memory coupled to the processor, wherein the memory includes instructions that when executed cause the system to perform a method of visually displaying information, the method including: graphically displaying a stacked item within a list; in response to user interaction with the stacked item, expanding the stacked item and displaying duplicate individual items within the stacked item as part of the list, wherein the duplicate individual items include a common body portion and different identifying information; and in response to user interaction with the list, collapsing the duplicate individual items and displaying the duplicate individual items as the stacked item.

In some system embodiments, the stacked item includes a chevron shaped on-screen tool, the expanding is performed in response to user interaction with the chevron shaped on-screen tool, and the collapsing is performed in response to user interaction with the chevron shaped on-screen tool. In further system embodiments, the stacked item includes at least one of an icon, a name, a date, and a number representing the number of the duplicate individual items represented by the stacked item. In one system embodiment, the method further includes displaying the list as a group view, wherein the stacked item includes: an author; and a number representing the number of the duplicate individual items represented by the stacked item.

In various system embodiments, the method further includes displaying the list as an expanded view, wherein the stacked item includes: an author, a subject/filename, a date, a status, and a type. In one system embodiment, the method further includes, in response to user interaction with at least one of the stacked item and the duplicate individual items, displaying the common body portion.

These and other objects and advantages of the various embodiments of the present invention will be recognized by those of ordinary skill in the art after reading the following detailed description of the embodiments that are illustrated in the various drawing figures.

### BRIEF DESCRIPTION OF THE DRAWINGS

Embodiments of the present invention are illustrated by way of example, and not by way of limitation, in the figures of the accompanying drawings and in which like reference numerals refer to similar elements.

FIG. 1 is a block diagram depicting an exemplary network architecture that can serve as a platform for embodiments of the present invention.

FIG. 2 is a block diagram depicting a computer system suitable for implementing embodiments of the present invention.

FIG. 3 depicts an exemplary duplicate item display management system, according to an exemplary embodiment of the present invention.

FIG. 4 depicts an on-screen exemplary list of the duplicate item display management system with de-duplication turned off, according to an embodiment of the present invention.

FIG. 5 depicts an on-screen exemplary list of the duplicate items display management system with de-duplication turned on, according to an embodiment of the present invention.

FIG. 6 depicts an on-screen exemplary list of the duplicate items display management system wherein chevron shaped on-screen tool controls have expanded duplicate items, according to an embodiment of the present invention.

FIG. 7 depicts an on-screen exemplary group list of the duplicate items display management system, according to an embodiment of the present invention.

FIG. 8 depicts an on-screen exemplary expanded view list of the duplicate items display management system, according to an embodiment of the present invention.

FIG. 9 depicts an on-screen exemplary expanded view list of the duplicate items display management system wherein chevron shaped on-screen tool controls have expanded and collapsed duplicate items, according to an embodiment of the present invention.

FIG. 10 depicts an on-screen exemplary preview and an exemplary list of the duplicate item display management system with de-duplication turned on, according to an embodiment of the present invention.

FIG. 11 depicts an on-screen exemplary preview and an exemplary list of the duplicate item display management system wherein chevron shaped on-screen tool controls have expanded duplicate items, according to an embodiment of the present invention.

FIG. 12 depicts an on-screen exemplary preview and an exemplary list of the duplicate item display management system wherein chevron shaped on-screen tool controls have expanded and collapsed duplicate items, according to an embodiment of the present invention.

FIG. 13 depicts an on-screen exemplary filter, an exemplary preview, and an exemplary list of the duplicate item display management system, according to an embodiment of the present invention.

FIG. 14 depicts an on-screen exemplary filter, an exemplary preview, and an exemplary expanded view list of the duplicate item display management system, according to an embodiment of the present invention.

FIG. 15 depicts an exemplary computer controlled flow diagram of a method of managing the display of duplicate items in a list, according to an embodiment of the present invention.

FIG. 16 depicts an exemplary computer controlled flow diagram of a method of managing duplicate items in a list according to an embodiment of the present invention.

### DETAILED DESCRIPTION

Reference will now be made in detail to embodiments in accordance with the present invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail as not to unnecessarily obscure aspects of the embodiments of the present invention.

Some portions of the detailed descriptions, which follow, are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. A procedure, computer-executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “encoding,” “decoding,” “receiving,” “sending,” “using,” “applying,” “calculating,” “incrementing,” “comparing,” “selecting,” “summing,” “weighting,” “computing,” “accessing” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

By way of example, and not limitation, computer-usable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, random access memory (RAM), read only memory (ROM), electrically erasable programmable ROM (EEPROM), flash memory or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information.

Communication media can embody computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. Combinations of any of the above should also be included within the scope of computer-readable media.

In the discussion that follows, unless otherwise noted, a “connected” refers to communicatively coupling elements via a bus, wireless connection (wifi), Bluetooth, infrared, USB, Ethernet, FireWire, optical, PCI, DVI, etc.

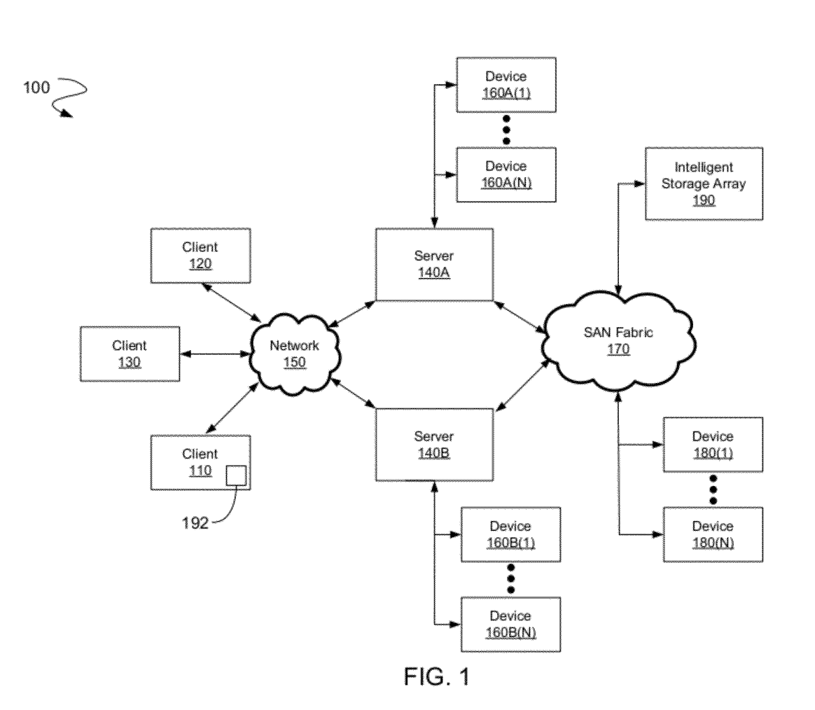

FIG. 1 is an exemplary system in which embodiments of the present invention can be implemented to manage the display of duplicate items in a list.

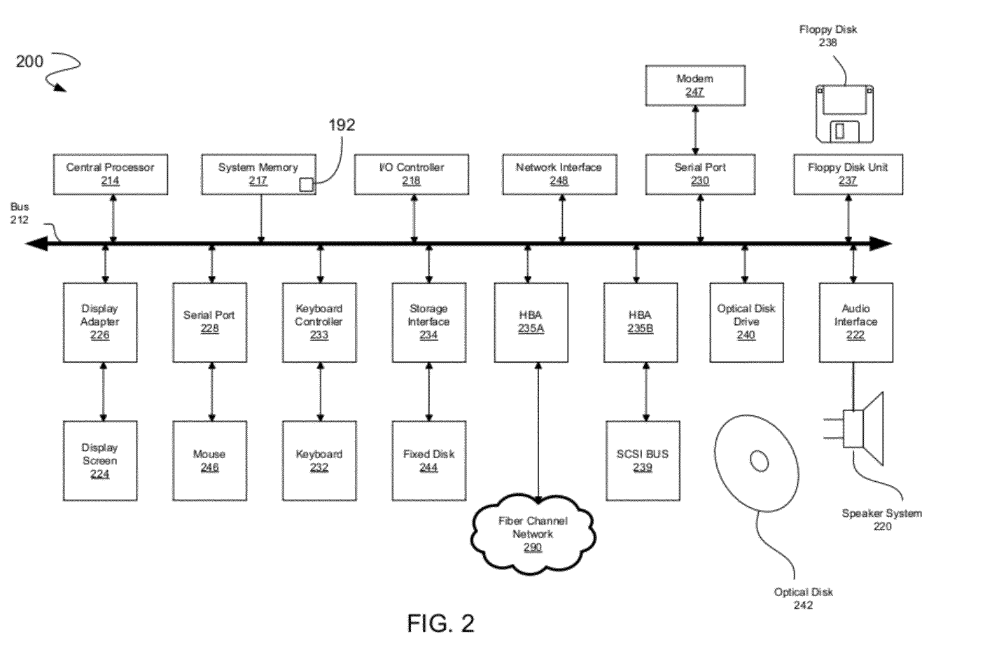

FIG. 1 is a block diagram depicting a network architecture 100 in which client systems 110, 120, and 130, as well as storage servers 140A and 140B (any of which can be implemented using computer system 200 (FIG. 2)), are coupled to a network 150. Storage server 140A is further depicted as having storage devices 160A(1)-(N) directly attached, and storage server 140B is depicted with storage devices 160B(1)-(N) directly attached. Servers 140A and 140B may contain a plurality of files that may be shared among a plurality of users. Storage servers 140A and 140B are also connected to a SAN fabric 170, although connection to a storage area network is not required for operation of the disclosure. SAN fabric 170 supports access to storage devices 180(1)-(N) by storage servers 140A and 140B, and so by client systems 110, 120, and 130 via network 150. Intelligent storage array 190 is also shown as an example of a specific storage device accessible via SAN fabric 170.

With reference to computer system 200 (FIG. 2), modem 247 (FIG. 2), network interface 248 (FIG. 2), or some other method can be used to provide connectivity from each of client computer systems 110, 120, and 130 to network 150. Client systems 110, 120, and 130 of FIG. 1 are able to access information on storage server 140A or 1408 using, for example, a web browser or other client software (not shown). Such a client allows client systems 110, 120, and 130 to access data hosted by storage server 140A or 1408 or one of storage devices 160A(1)-(N), 160B(1)-(N), 180(1)-(N), or intelligent storage array 190. FIG. 1 depicts the use of a network such as the Internet or exchanging data, but the embodiments of the present invention are not limited to the Internet or any particular network-based environment. In the present embodiments, a method of duplicate item display 192 may be performed in one of the client computer systems 110, 130, and 130. However, the method of duplicate item display 192 is not limited to the client computer systems 110, 130, and 130, and may also operate within, for example, storage server 140A or 140B. In addition, the method of duplicate item display 192 may also operate within cloud computing environments.

FIG. 2 depicts a block diagram of a computer system 200 suitable for implementing embodiments of the present invention. In the discussion to follow, various and numerous components and elements are described. Various combinations and subsets of those components can be used to implement the devices mentioned in conjunction with FIG. 1. For example, client systems 110, 120, and 130 may each be a full-function computer system that employs many, if not all, of the features of the computer system 200. However, the servers 140A and 1408 may utilize only the subset of those features needed to support the functionality provided by those devices. For example, the servers 140A and 140B may not need a keyboard or display, and may execute a relatively sparse operating system that supports the functionality of data storage and data access and the management of such functionality.

Computer system 200 of FIG. 2 includes a bus 212 which interconnects major subsystems of computer system 200, such as a central processor 214, a system memory 217 (typically RAM, but which may also include ROM, flash RAM, or the like), an input/output controller 218, an optional external audio device, such as a speaker system 220 via an audio output interface 222, an optional external device, such as a display screen 224 via display adapter 226, serial ports 228 and 230, an optional keyboard 232 (interfaced with a keyboard controller 233), an optional storage interface 234, an optional floppy disk unit 237 operative to receive a floppy disk 238, an optional host bus adapter (HBA) interface card 235A operative to connect with a Fibre Channel network 290, an optional host bus adapter (NBA) interface card 235B operative to connect to a SCSI bus 239, and an optional optical disk drive 240 operative to receive an optical disk 242. Also, optionally included can be a mouse 246 (or other point-and-click device, coupled to bus 212 via serial port 228), a modem 247 (coupled to bus 212 via serial port 230), and a network interface 248 (coupled directly to bus 212).

Bus 212 allows data communication between central processor 214 and system memory 217, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with computer system 200 are generally stored on and accessed via a computer readable medium, such as a hard disk drive (e.g., fixed disk 244), an optical drive (e.g., optical drive 240), a floppy disk unit 237, or other storage medium. Additionally, applications can be in the form of electronic signals modulated in accordance with the application and data communication technology when accessed via network modem 247 or network interface 248. In the current embodiment, the system memory 217 comprises instructions that when executed cause the system to perform the method of duplicate item display 192.

Storage interface 234, as with the other storage interfaces of computer system 200, can connect to a standard computer readable medium for storage and/or retrieval of information, such as fixed disk drive 244. Fixed disk drive 244 may be part of computer system 200 or may be separate and accessed through other interface systems. Modem 247 may provide a direct connection to a remote server via a telephone link or to the Internet via an internet service provider (ISP). Network interface 248 may provide a direct connection to a remote server via a direct network link to the Internet via a POP (point of presence). Network interface 248 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, all of the devices shown in FIG. 2 need not be present to practice the present disclosure. The devices and subsystems can be interconnected in different ways from that shown in FIG. 2. The operation of a computer system such as that shown in FIG. 2 is readily known in the art and is not discussed in detail in this application. Code to implement the present disclosure can be stored in computer-readable storage media such as one or more of system memory 217, fixed disk 244, optical disk 242, or floppy disk 238. The operating system provided on computer system 200 may be MS-DOS®, MS-WINDOWS®, OS/2®, UNIX®, Linux®, or another known operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present disclosure may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

### Method and System for Managing the Display of Duplicate Items in a Display

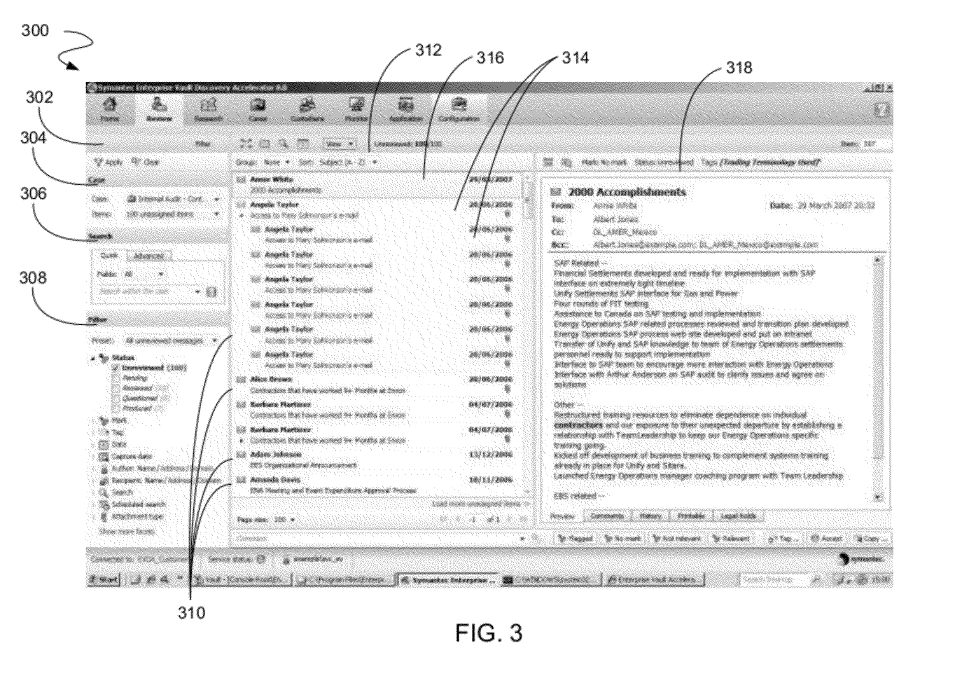

FIG. 3 depicts an exemplary duplicate item display management system 300, according to an exemplary embodiment of the present invention. Embodiments of the present invention provide methods and systems for managing the display of duplicate items in a list. In some embodiments, archives may need to be searched and data collected. The collected data is expected to include many duplicate items. The duplicate item display management system 300 displays the duplicate items together under an on-screen graphical user interface tool or header, e.g. stack head on-screen tool. The stack head on-screen tool may be expanded to display all of the duplicate items, or collapsed to display only the stack head on-screen tool.

In an embodiment, a filter window 302 includes a case filter 304, a search filter 306, and a facet filter 308. Selections within the case filter 304, the search filter 306, and the facet filter 308 may be used to search for items, e.g. documents, electronic mail messages (email), files, and programs, within data archives.

Items 310 that meet the search filters within the filter window 302 are then displayed in a list 312. The list 312 groups duplicate items 314 under a stack head on-screen tool 316. Thus, the stack head on-screen tool 316 is a graphical representation of the duplicate items 314. In an embodiment, a user may select one of the items 310 and a preview 318 is displayed. The preview 318 may include details of one or more of the items 310.

For example, a user may select search criteria within the filter window 302. The search criteria may be for emails including the term “contractors.” Emails matching the search criteria are displayed as the items 310 in the list 312. In some cases, emails were sent to many recipients, thus creating many duplicate emails. Therefore, the duplicate item display management system 300 displays the duplicate emails together under the stack head on-screen tool 316. In some embodiments, the duplicate emails may be collapsed, leaving only the stack head on-screen tool 316 displayed. Emails within the list 312 may be selected and displayed in the preview 318.

It will be appreciated that the exemplary embodiment of the duplicate item display management system 300 is only an example of many uses for the duplicate item display management system 300 in accordance with embodiments of the present invention. Embodiments of the present invention can be used in any case where information needs to be collected and displayed. For example, during legal e-discovery a reviewer may need to verify information before transmittal.

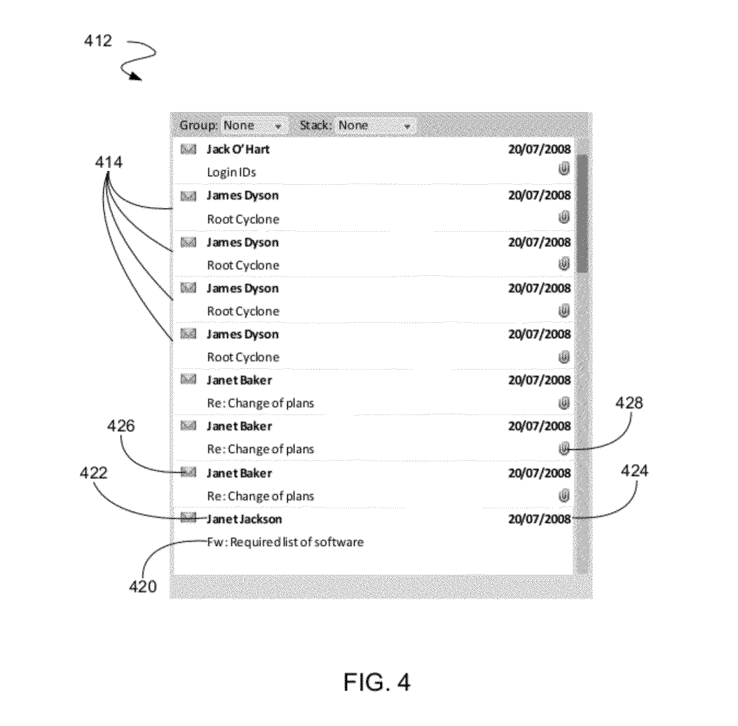

FIG. 4 depicts an exemplary list 412 of the duplicate item display management system 300 (FIG. 3), according to an embodiment of the present invention. The exemplary list 412 has de-duplication functionality turned off. Thus, on-screen stack head tools 316 (FIG. 3) are no longer displayed, and duplicate items 414 are listed one after another. As a result, the duplicate items 414 are not consolidated within a stack head on-screen tool.

In an embodiment, the duplicate items 414 may include visual attributes. For example, the duplicate items 414 may include one or more of an email subject line 420, an email sender 422, a date 424, an email graphic 426, an attachment graphic 428, a file name (not shown), and an email recipient (not shown).

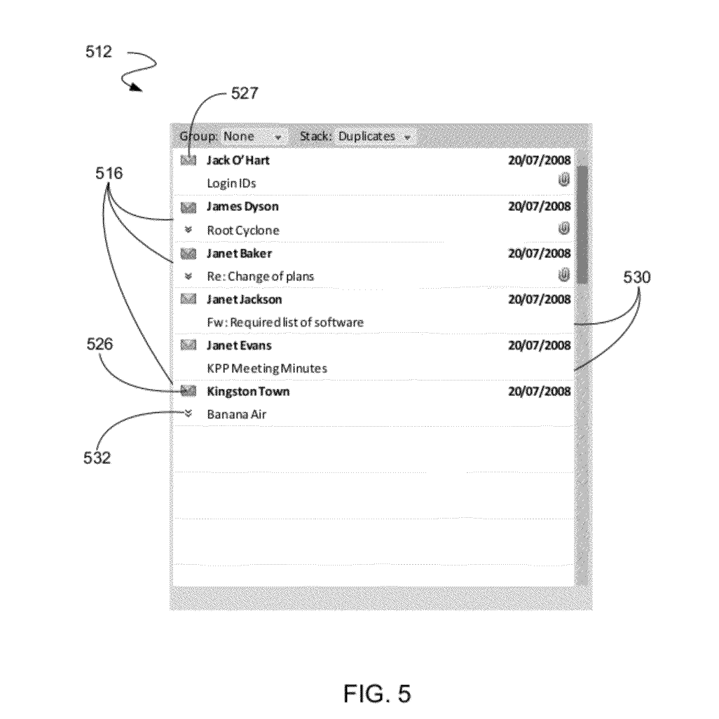

FIG. 5 depicts an exemplary list 512 of the duplicate items display management system 300 (FIG. 3), according to an embodiment of the present invention. The exemplary list 512 has de-duplication functionality in accordance with embodiments of the present invention turned on. Thus, stack head on-screen tools 516 are displayed, and duplicate items 414 (FIG. 4) are no longer displayed. The stack head on-screen tools 516 are a single visual representation, or graphical user interface on-screen tool, of the duplicate items 414 (FIG. 4). As a result, the duplicate items 414 (FIG. 4) are consolidated within the stack head on screen tools 516.

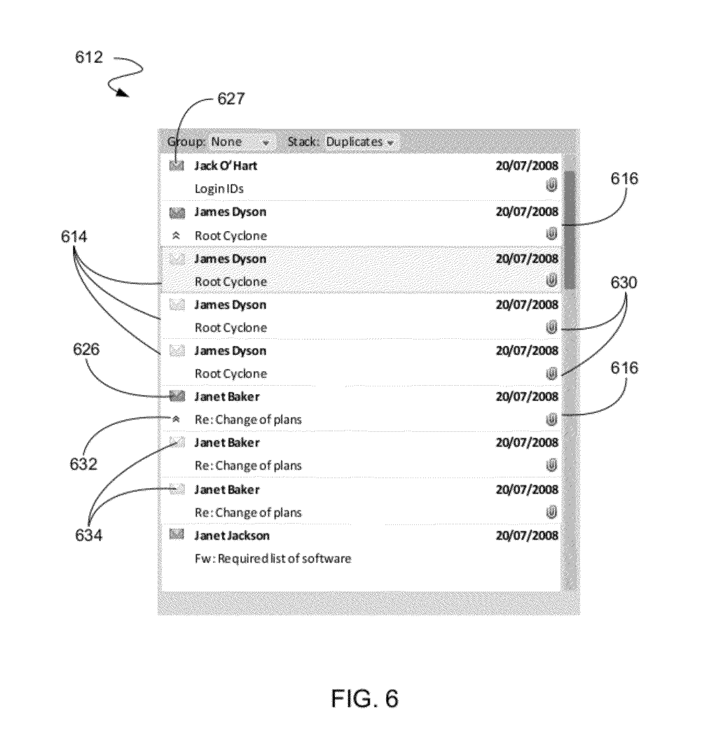

In an embodiment, a stack icon 526 for stack head on-screen tool 516 may be different from a single icon 527 for single/unique items 530. For example, in an embodiment, the stack icon 526 may be represented by a stack of email icons. In addition, the single icon 527 may be represented by a single email icon. In various embodiments, a graphical user interface (“GUI”) control, e.g. a chevron shaped on-screen tool control 532, may be included in the stack head on-screen tool 516. The chevron shaped on-screen tool control 532 may expand and collapse display of the duplicate items (see FIG. 6).

FIG. 6 depicts an exemplary list 612 of the duplicate items display management system 300 (FIG. 3), according to an embodiment of the present invention. The exemplary list 612 has de-duplication functionality turned on and chevron shaped on-screen tool controls 632 have expanded duplicate items 614. Thus, stack head on-screen tools 616 are displayed, and duplicate items 614 are displayed under the stack head on-screen tools 616.

In an embodiment, a duplicate item icon 634 for the duplicate items 614 may be different from a single icon 627 for single/unique items 630. In addition, the duplicate item icon 634 may also be different from a stack icon 626 for the stack head on-screen tools 616. For example, in an embodiment, the stack icon 626 may be represented by a stack of email icons, and the duplicate item icon 634 may be represented by a lighter color and/or shade of a stack of email icons. In addition, the single icon 627 may be represented by a single email icon.

In various embodiments, the chevron shaped on-screen tool control 632 may be included in the stack head on-screen tools 616. User interaction with the chevron shaped on-screen tool control 632 may expand and collapse display of the duplicate items 614. Thus, chevron shaped on-screen tool control 632 may toggle between the exemplary list 512 in FIG. 5 and the exemplary list 612 in FIG. 6.

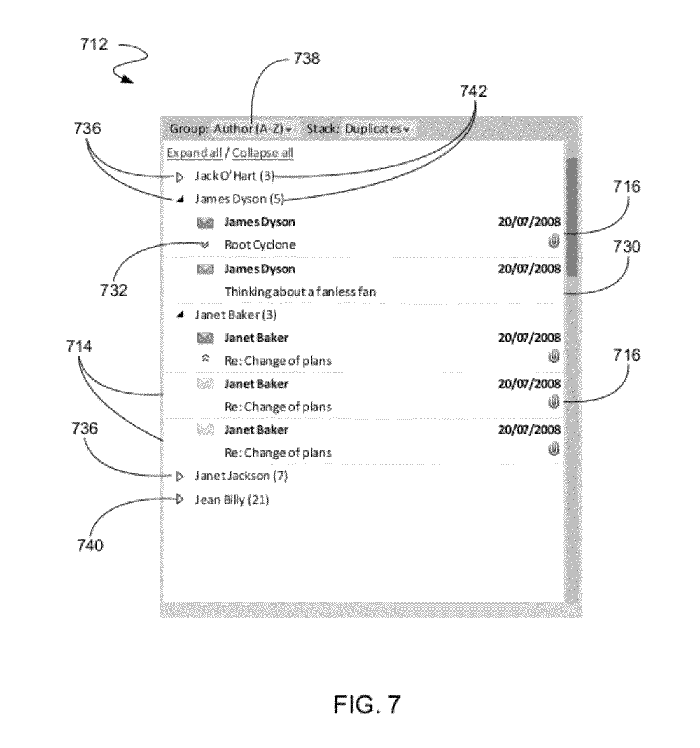

FIG. 7 depicts an exemplary on-screen list 712 of the duplicate items display management system 300 (FIG. 3), according to an embodiment of the present invention. The exemplary list 712 is a group view wherein duplicate items 714, stack head on-screen tools 716, and single/unique items 730 are grouped together into groups 736 according to selected criteria 738.

In an embodiment, a user may expand and collapse the groups 736, for example by selecting on-screen group icon 740. In some embodiments, the user may expand and collapse the stack head on-screen tools 716, for example by selecting stack icon 732. In various embodiments, representations 742 of the number of items within the groups 736 are displayed.

For example, a user may select a group view according to first names. Thus, the exemplary list 712 displays a list of the groups 736 sorted by first names. Each of the groups 736 includes a number, e.g. representations 742, of the items within each group 736. The number may include the total number of stack head on-screen tools 716, duplicate items 714, and single/unique items 730 grouped together.

The user may select group icon 740 to expand one or more of the groups 736, thus displaying the stack head on-screen tools 716 and the single/unique items 730 within the groups 736. In addition, the user may select stack icon 732 to expand one or more of the stack head on-screen tools 716, thus displaying the duplicate items 714 within the stack head on-screen tools 716.

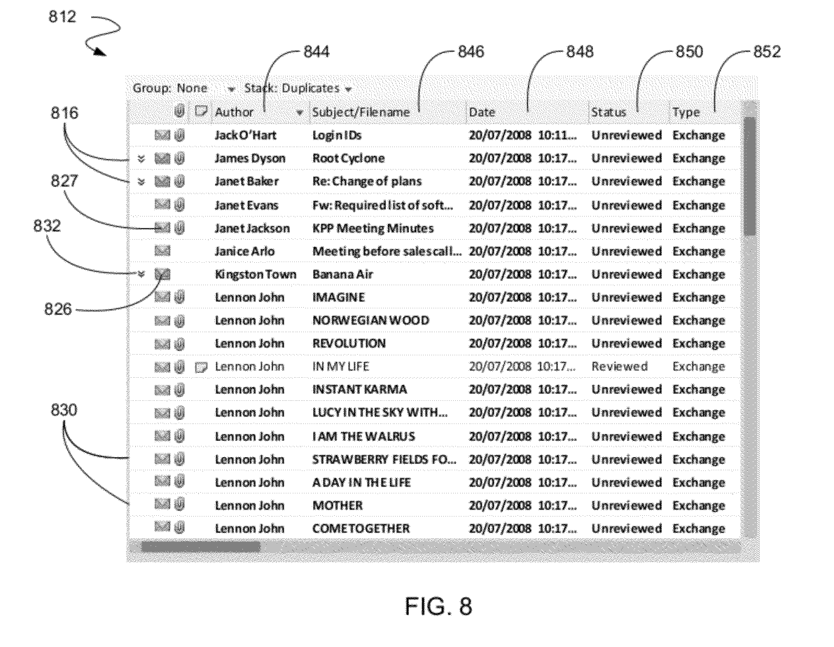

FIG. 8 depicts an on-screen exemplary list 812 of the duplicate items display management system 300 (FIG. 3), according to an embodiment of the present invention. The exemplary list 812 is an expanded view and may contain more information than, for example, the exemplary list 512 (FIG. 5). Thus, the exemplary list 812 may include, for example, author 844, subject/filename 846, date 848, status 850, and type 852, e.g. file type.

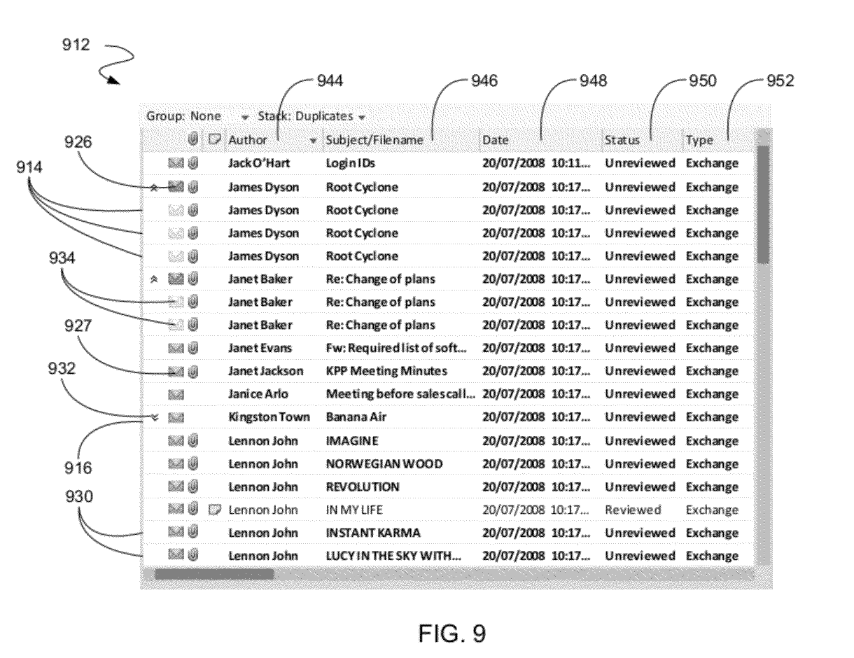

In an embodiment, on-screen stack head on-screen tools 816 are displayed, and duplicate items 914 (see FIG. 9) are not displayed. The stack head on-screen tools 816 are a single visual representation of the duplicate items 914 (see FIG. 9). As a result, the duplicate items 914 (see FIG. 9) are consolidated within the stack head on-screen tools 816.

In an embodiment, a stack icon 826 for stack head on-screen tools 816 may be different from a single icon 827 for single/unique items 830. For example, in an embodiment, the stack icon 826 may be represented by a stack of email icons. In addition, the single icon 827 may be represented by a single email icon. In various embodiments, a control, e.g. a chevron shaped on-screen tool control 832, may be included in the stack head on-screen tools 816. The chevron shaped on-screen tool control 832 may expand and collapse display of the duplicate items (see FIG. 9).

FIG. 9 depicts an on-screen exemplary list 912 of the duplicate items display management system 300 (FIG. 3), according to an embodiment of the present invention. The exemplary list 912 has expanded duplicate items 914. Thus, on-screen stack head on-screen tools 916 are displayed, and duplicate items 914 are displayed under the stack head on-screen tools 916. In addition, the exemplary list 912 is an expanded view and may contain more information than, for example, the exemplary list 612 (FIG. 6). Therefore, the exemplary list 912 may include, for example, author 944, subject/filename 946, date 948, status 950, and type 952, e.g. file type.

In an embodiment, a duplicate item icon 934 for the duplicate items 914 may be different from a single icon 927 for single/unique items 930. In addition, the duplicate item icon 934 may also be different from a stack icon 926 for the stack head on-screen tools 916. For example, in an embodiment, the stack icon 926 may be represented by a stack of email icons, and the duplicate item icon 934 may be represented by a lighter stack of email icons. In addition, the single icon 927 may be represented by a single email icon.

In various embodiments, the chevron shaped on-screen tool control 932 may be included in the stack head on-screen tools 916. The chevron shaped on-screen tool control 932 may expand and collapse display of the duplicate items 914. Thus, chevron shaped on-screen tool control 932 may toggle between the exemplary list 812 in FIG. 8 and the exemplary list 912 in FIG. 9.

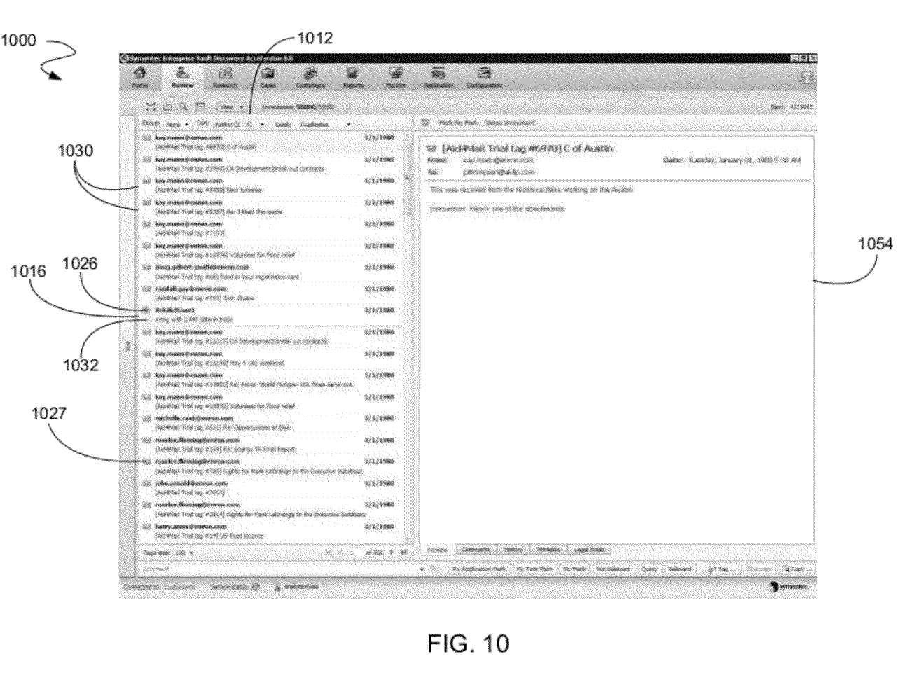

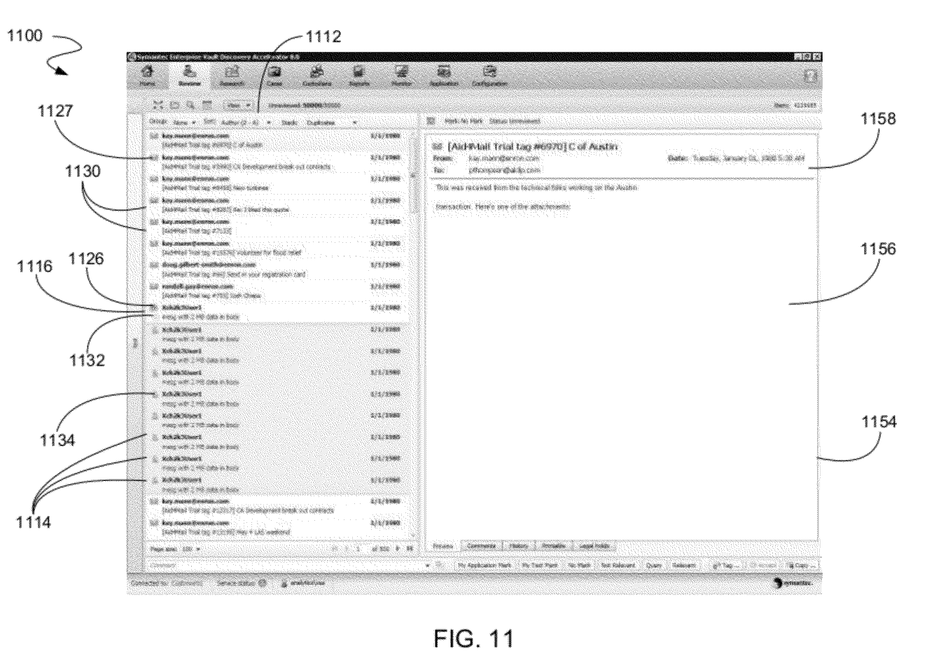

FIG. 10 depicts an exemplary duplicate display management system 1000, according to an embodiment of the present invention. An exemplary on-screen list 1012 has de-duplication turned on. Thus, stack head on-screen tools 1016 are displayed, and duplicate items 1114 (see FIG. 11) are collapsed into the stack header 1016. The stack head on-screen tools 1016 are a visual representation of the duplicate items 1114 (see FIG. 11). As a result, the duplicate items 1114 (see FIG. 11) are consolidated within the stack head on-screen tools 1016. In some embodiments, the duplicate items 1114 (see FIG. 11) are collapsed by default into the stack head on-screen tools 1016.

In an embodiment, a stack icon 1026 for stack head on-screen tools 1016 may be different from a single icon 1027 for single/unique items 1030. For example, in an embodiment, the stack icon 1026 may be represented by a stack of email icons. In addition, the single icon 1027 may be represented by a single email icon. In various embodiments, a control, e.g. a chevron shaped on-screen tool control 1032, may be included in the stack head on-screen tools 1016. The chevron shaped on-screen tool control 1032 may expand and collapse display of the duplicate items 1114 (see FIG. 11).

In some embodiments, a preview 1054 may display details of one or more items in the exemplary list 1012. For example, the preview 1054 may display details of an email represented by one or more of the stack head on-screen tools 1016, the duplicate items 1114 (see FIG. 11), and the single/unique items 1030.

FIG. 11 depicts an exemplary duplicate display management system 1100, according to an embodiment of the present invention. The exemplary duplicate display management system 1100 includes an on-screen exemplary preview 1154 and an exemplary list 1112 of the exemplary duplicate item display management system 1100. The exemplary list 1112 has de-duplication turned on and chevron shaped on-screen tool controls 1132 have expanded duplicate items 1114. Thus, stack head on-screen tools 1116 are displayed, and duplicate items 1114 are displayed under the stack head on-screen tools 1116. In some embodiments, the duplicate items 1114 are expanded by default under the stack head on-screen tools 1116.

In an embodiment, a duplicate item icon 1134 for the duplicate items 1114 may be different from a single icon 1127 for single/unique items 1130. In addition, the duplicate item icon 1134 may also be different from a stack icon 1126 for the stack head on-screen tools 1116. For example, in an embodiment, the stack icon 1126 may be represented by a stack of email icons, and the duplicate item icon 1134 may be represented by a lighter stack of email icons. In addition, the single icon 1127 may be represented by a single email icon.

In various embodiments, the chevron shaped on-screen tool control 1132 may be included in the stack head on-screen tools 1116. The chevron shaped on-screen tool control 1132 may expand and collapse display of the duplicate items 1114. Thus, chevron shaped on-screen tool control 1132 may toggle between the exemplary list 1012 in FIG. 10 and the exemplary list 1112 in FIG. 11.

In various embodiments, the preview 1154 may display details of one or more items in the exemplary list 1112. For example, the preview 1154 may display details of an email represented by one or more of the stack head on-screen tools 1116, the duplicate items 1114, and the single/unique items 1130. In an embodiment, the preview 1154 may be displayed in response to user interaction with the stack head on-screen tools 1116, the duplicate items 1114, and/or the single/unique items 1130.

In some embodiments, the duplicate items 1114 and/or the stack head on-screen tools 1116 may include a common body portion 1156 and different identifying information 1158. For example, an email sent to a number of recipients may include the same information within the common body portion 1156, however recipient and sender information within the different identifying information 1158 may be dissimilar between senders and recipients within the duplicate items 1114.

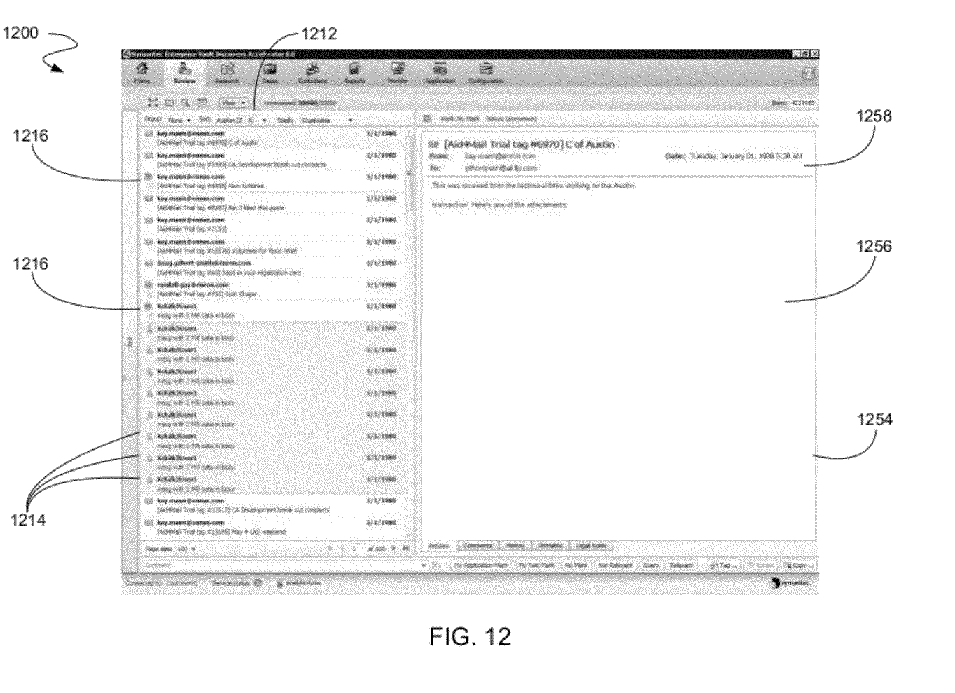

FIG. 12 depicts an exemplary duplicate display management system 1200, according to an embodiment of the present invention. The exemplary duplicate display management system 1200 includes an on-screen exemplary preview 1254 and an exemplary list 1212 of the exemplary duplicate item display management system 1200. Within the exemplary list 1212 chevron shaped on-screen tool controls 1232 have both expanded duplicate items 1214 and collapsed duplicate items 1214. Thus, duplicate items 1214 are displayed under some stack head on-screen tools 1216, and duplicate items 1214 are collapsed under other stack head on-screen tools 1216. Accordingly, a user may selectively expand and collapse selected duplicate items 1214 using the chevron shaped on-screen tool controls 1232.

In various embodiments, the preview 1254 may display details of one or more items in the exemplary list 1212. For example, the preview 1254 may display details of an email represented by one or more of the stack head on-screen tools 1216, the duplicate items 1214, and the single/unique items 1230.

In some embodiments, the duplicate items 1214 and/or the stack head on-screen tools 1216 may include a common body portion 1256 and different identifying information 1258. For example, an email sent to a number of recipients may include the same information within the common body portion 1256, however recipient and sender information within the different identifying information 1258 may be dissimilar between senders and recipients within the duplicate items 1214.

In various embodiments, a user may select one or more of the stack head on-screen tools 1216 with expanded or collapsed duplicate items 1214. Selection of the stack head on-screen tools 1216 may cause the display of at least the common body portion 1256 within the preview 1254. Thus a user may select either the stack head on-screen tools 1216 or the corresponding duplicate items 1214 to view the common body portion 1256.

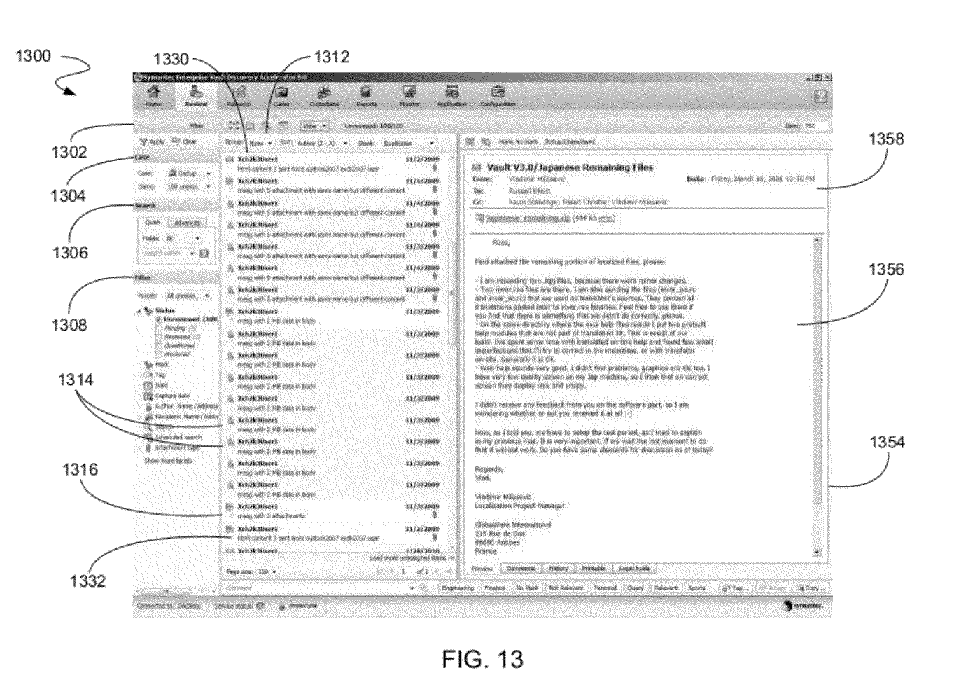

FIG. 13 depicts an exemplary duplicate display management system 1300, according to an embodiment of the present invention. The exemplary duplicate display management system 1300 includes an exemplary filter, an on-screen exemplary preview, and an exemplary list of the duplicate item display management system 1300. A filter window 1302 includes a case filter 1304, a search filter 1306, and a facet filter 1308. Selections within the case filter 1304, the search filter 1306, and the facet filter 1308 may be used to search for items, e.g. documents, electronic mail messages (email), files, and programs, within data archives.

Within an exemplary list 1312 chevron shaped on-screen tool controls 1332 have both expanded duplicate items 1314 and collapsed duplicate items 1314. Thus, duplicate items 1314 are displayed under some stack head on-screen tools 1316, and duplicate items 1314 are collapsed under other stack head on-screen tools 1316. Accordingly, a user may selectively expand and collapse selected duplicate items 1314 using the chevron shaped on-screen tool controls 1332.

In various embodiments, a preview 1354 may display details of one or more items in the exemplary list 1312. For example, the preview 1354 may display details of an email represented by one or more of the stack head on-screen tools 1316, the duplicate items 1314, and the single/unique items 1330.

In some embodiments, the duplicate items 1314 and/or the stack head on-screen tools 1316 may include a common body portion 1356 and different identifying information 1358. For example, an email sent to a number of recipients may include the same information within the common body portion 1356, however recipient and sender information within the different identifying information 1358 may be dissimilar between senders and recipients within the duplicate items 1314.

In various embodiments, a user may select one or more of the stack head on-screen tools 1316 with expanded or collapsed duplicate items 1314. Selection of the stack head on-screen tools 1316 may cause the display of at least the common body portion 1356 within the preview 1354. Thus a user may select either the stack head on-screen tools 1316 or the corresponding duplicate items 1314 to view the common body portion 1356.

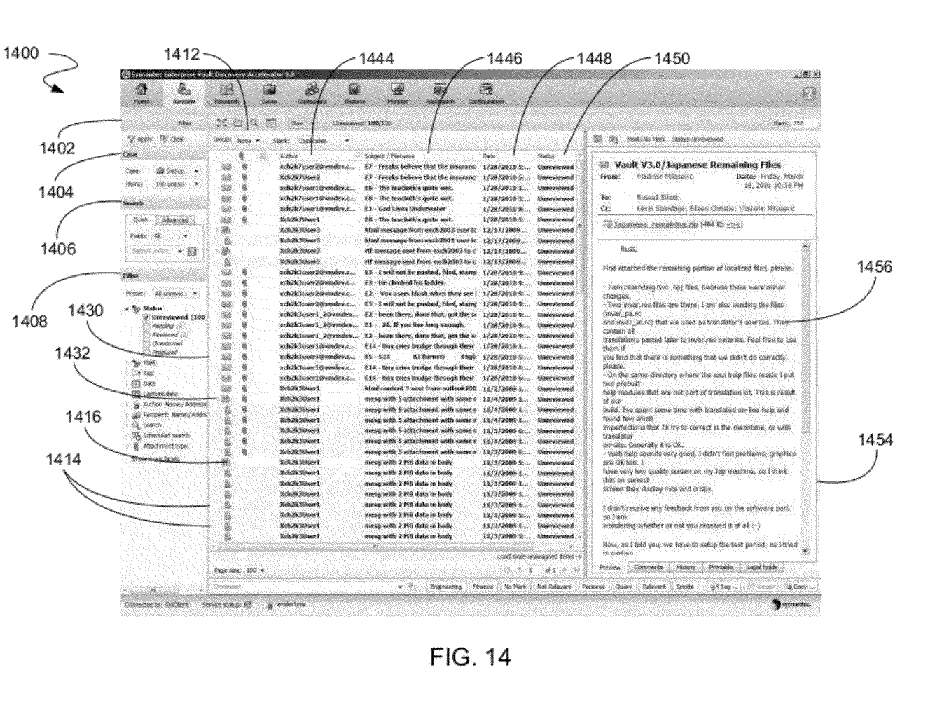

FIG. 14 depicts an exemplary duplicate display management system 1400, according to an embodiment of the present invention. The exemplary duplicate display management system 1400 includes an exemplary filter, an on-screen exemplary preview, and an exemplary expanded view list of the duplicate item display management system 1300. A filter window 1402 includes a case filter 1404, a search filter 1406, and a facet filter 1408. Selections within the case filter 1404, the search filter 1406, and the facet filter 1408 may be used to search for items, e.g. documents, electronic mail messages (email), files, and programs, within data archives.

An exemplary list 1412 is an expanded view and may contain more information than, for example, the exemplary list 1312 (FIG. 13). Thus, the exemplary list 1412 may include, for example, author 1444, subject/filename 1446, date 1448, status 1450, and type (not shown), e.g. file type. Within the exemplary list 1412 chevron shaped on-screen tool controls 1432 have expanded duplicate items 1414. In some embodiments, the duplicate items 1414 are expanded by default under the stack head on-screen tools 1416. In various embodiments, a user may selectively expand and collapse selected duplicate items 1414 using the chevron shaped on-screen tool controls 1432.

In some embodiments, a preview 1454 may display details of one or more items in the exemplary list 1412. For example, the preview 1454 may display details of an email represented by one or more of the stack head on-screen tools 1416, the duplicate items 1414, and single/unique items 1430.

In various embodiments, a user may select one or more of the stack head on-screen tools 1416 or the duplicate items 1414. Selection of the stack head on-screen tools 1416 may cause the display of at least a common body portion 1456 within the preview 1454. Thus, a user may select either the stack head on-screen tools 1416 or the corresponding duplicate items 1414 to view the common body portion 1456.

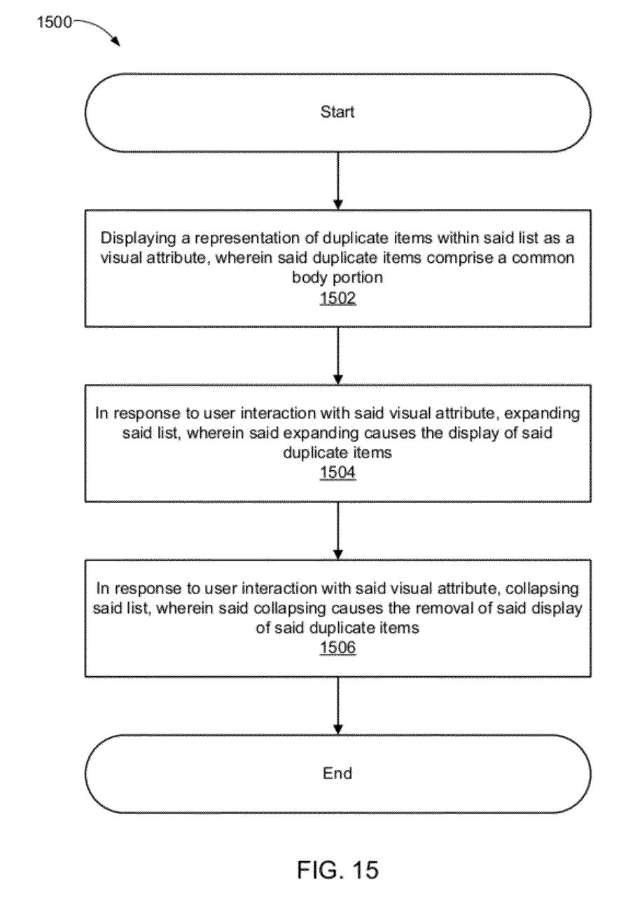

FIG. 15 depicts a flowchart 1500 of an exemplary computer controlled method of managing the display of duplicate items in a list, according to an embodiment of the present invention. Although specific steps are disclosed in the flowchart 1500, such steps are exemplary. That is, embodiments of the present invention are well-suited to performing various other steps or variations of the steps recited in the flowchart 1500. The flowchart 1500 can be implemented as computer-executable instructions residing on some form of computer-usable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In a step 1502, a representation of duplicate items within the list is displayed as a visual attribute, wherein the duplicate items include a common body portion. For example, in FIG. 5 the stack head on-screen tools are visual representations of the duplicate items. In addition, in FIG. 11 the common body portion is the same between duplicate items under a stack head on-screen tool.

In some embodiments the visual attribute is a visual representation of a file name, an electronic mail message subject line, an electronic mail message sender, and an electronic mail message recipient. For example, in FIG. 5 the visual attributes are the names of electronic mail message senders. In addition, the visual attributes include the subject line of the electronic mail message.

In various embodiments, the visual attribute includes at least one of an icon, a name, a date, and a number representing the number of the duplicate items represented by the visual attribute. For example, in FIG. 7 the groups include group icons, names, and dates. In addition the groups include a number that represents the number of duplicate items within the group.

In an embodiment, the list is displayed as a group view, wherein the visual attribute may include an author. In addition, the visual attribute may include a number that represents the number of the duplicate items represented by the visual attribute. For example, in FIG. 7 the duplicate items have been grouped together. The visual attribute representing the groups are the names of the authors of electronic mail messages. Furthermore, a number indicates how many items are grouped together.

In a step 1504, in response to user interaction with the visual attribute, the list is expanded, wherein the expanding causes the display of the duplicate items. For example, in FIG. 6 a user may select a chevron shaped on-screen tool control to expand and collapse duplicate items collected together under a stack head on-screen tool.

In some embodiments, the list is displayed as an expanded view, wherein the visual attribute includes: an author, a subject/filename, a date, a status, and a type. For example, in FIG. 8 the expanded view displays more information than, for example, in FIG. 7. The expanded view in FIG. 8 includes an author, a subject/filename, a date, a status, and a type, e.g. file type.

In a step 1506, in response to user interaction with the visual attribute, the list is collapsed, wherein the collapsing causes the removal of the display of the duplicate items. For example, in FIG. 5 a user may have selected the chevron shaped on-screen tool control to collapse the duplicate items. The duplicate items are no longer displayed and are represented by the stack head on-screen tool.

In various embodiments, the visual attribute is a chevron shaped on-screen tool. In addition, the expanding is performed in response to user interaction with the chevron shaped on-screen tool, and the collapsing is performed in response to user interaction with the chevron shaped on-screen tool. For example, in FIG. 5 and FIG. 6 a user may click on the chevron shaped on-screen tool to expand and collapse the duplicate items under the stack head on-screen tools.

In some embodiments, in response to user interaction with the visual attribute and/or at least one of the duplicate items, a preview of the common body portion is displayed. For example, in FIG. 11 the preview may display details of an email represented by one or more of the stack head on-screen tools, the duplicate items, and the single/unique items. The preview may be displayed in response to user interaction with the stack head on-screen tools, the duplicate items, and/or the single/unique items.

FIG. 14 depicts an exemplary duplicate display management system 1400, according to an embodiment of the present invention. An on-screen filter window 1402 includes a case filter 1404, a search filter 1406, and a facet filter 1408. Selections within the case filter 1404, the search filter 1406, and the facet filter 1408 may be used to search for items, e.g. documents, electronic mail messages, files, and programs, within data archives.

An exemplary list 1412 is an expanded view and may contain more information than, for example, the exemplary list 1312 (FIG. 13). Thus, the exemplary list 1412 may include, for example, author 1444, subject/filename 1446, date 1448, status 1450, and type (not shown), e.g. file type. Within the exemplary list 1412 chevron shaped on-screen tool controls 1432 have expanded duplicate items 1414. In some embodiments, the duplicate items 1414 are expanded by default under the stack head on-screen tools 1416. In various embodiments, a user may selectively expand and collapse selected duplicate items 1414 using the chevron shaped on-screen tool controls 1432.

In some embodiments, a preview 1454 may display details of one or more items in the exemplary list 1412. For example, the preview 1454 may display details of an email represented by one or more of the stack head on-screen tools 1416, the duplicate items 1414, and single/unique items 1430.

In various embodiments, a user may select one or more of the stack head on-screen tools 1416 or the duplicate items 1414. Selection of the stack head on-screen tools 1416 may cause the display of at least a common body portion 1456 within the preview 1454. Thus, a user may select either the stack head on-screen tools 1416 or the corresponding duplicate items 1414 to view the common body portion 1456.

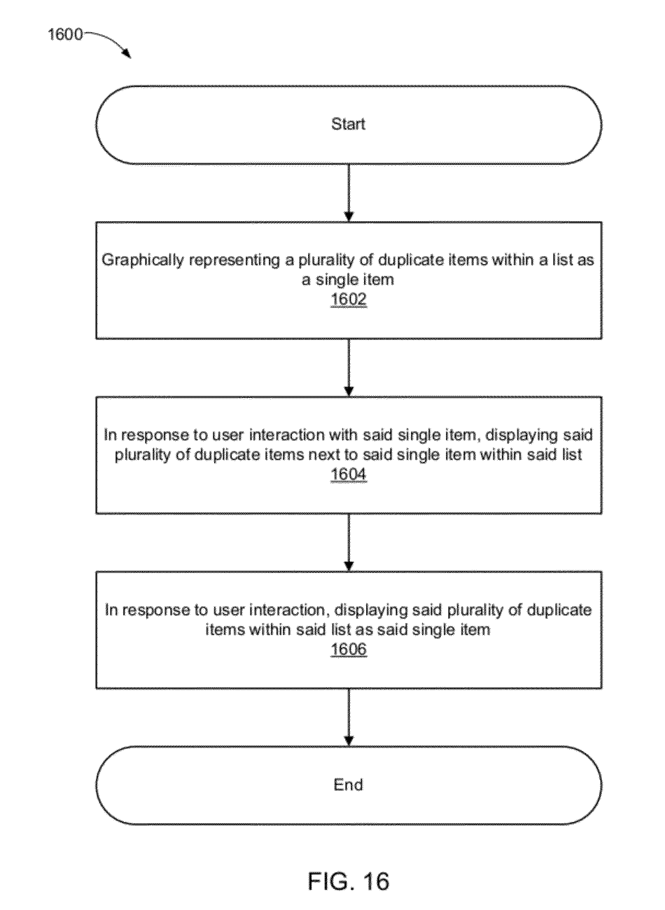

FIG. 16 depicts a flowchart 1600 of an exemplary computer controlled method of managing the display of duplicate items in a list, according to an embodiment of the present invention. Although specific steps are disclosed in the flowchart 1600, such steps are exemplary. That is, embodiments of the present invention are well-suited to performing various other steps or variations of the steps recited in the flowchart 1600. The flowchart 1600 can be implemented as computer-executable instructions residing on some form of computer-usable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In a step 1602, a number of duplicate items are graphically represented within a list as a single item. For example, in FIG. 5 the stack head on-screen tools are visual representations of the duplicate items. In addition, in FIG. 11 the common body portion is the same between duplicate items under a stack head on-screen tool.

In some embodiments the single item is a visual representation of a file name, an electronic mail message subject line, an electronic mail message sender, and an electronic mail message recipient. For example, in FIG. 5 the visual attributes are the names of electronic mail message senders. In addition, the visual attributes include the subject line of the electronic mail message.

In various embodiments, the single item includes at least one of an icon, a name, a date, and a number representing the number of the duplicate items. For example, in FIG. 7 the groups include group icons, names, and dates. In addition the groups include a number that represents the number of duplicate items within the group.

In an embodiment, the list is displayed as a group view, wherein the single item may include an author. In addition, the single item may include a number that represents the number of the duplicate items represented by the single item. For example, in FIG. 7 the duplicate items have been grouped together. The visual attribute representing the groups are the names of the authors of electronic mail messages. Furthermore, a number indicates how many items are grouped together.

In a step 1604, in response to user interaction with the single item, the number of duplicate items are displayed next to the single item within the list. For example, in FIG. 6 a user may select a chevron shaped on-screen tool control to expand and collapse duplicate items collected together under a stack head on-screen tool.

In some embodiments, the list is displayed as an expanded view, wherein the single item includes: an author, a subject/filename, a date, a status, and a type. For example, in FIG. 8 the expanded view displays more information than, for example, in FIG. 7. The expanded view in FIG. 8 includes an author, a subject/filename, a date, a status, and a type, e.g. file type.

In a step 1606, in response to user interaction, displaying the number of duplicate items within the list as the single item. For example, in FIG. 5 a user may have selected the chevron shaped on-screen tool control to collapse the duplicate items. The duplicate items are no longer displayed and are represented by the stack head on-screen tool.

In various embodiments, the single item is a chevron shaped on-screen tool. In addition, the displaying the number of duplicate items after the single item is performed in response to user interaction with the chevron shaped on-screen tool, and the displaying the number of duplicate items as the single item is performed in response to user interaction with the chevron shaped on-screen tool. For example, in FIG. 5 and FIG. 6 a user may click on the chevron shaped on-screen tool to expand and collapse the duplicate items under the stack head on-screen tools.

In some embodiments, in response to user interaction with the single item, a preview is displayed of the number of duplicate items. For example, in FIG. 11 the preview may display details of an email represented by one or more of the stack head on-screen tools, the duplicate items, and the single/unique items. The preview may be displayed in response to user interaction with the stack head on-screen tool, the duplicate items, and/or the single/unique items.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as may be suited to the particular use contemplated.

What is claimed is:

1. A method of displaying items in an on-screen list, said method comprising:
displaying a representation of duplicate items within said list as a visual attribute, wherein said duplicate items comprise a common body portion;
in response to user interaction with said visual attribute, expanding said list, wherein said expanding causes the display of said duplicate items; and
in response to user interaction with said visual attribute, collapsing said list, wherein said collapsing causes removal of said display of said duplicate items.

2. The method of claim 1 wherein said visual attribute is an on-screen visual representation tool selected from the group consisting of a file name, an electronic mail message subject line, an electronic mail message sender, and an electronic mail message recipient.

3. The method of claim 1 wherein:
said visual attribute comprises an on-screen chevron shaped tool,
said expanding is performed in response to user interaction with said chevron shaped tool, and
said collapsing is performed in response to user interaction with said chevron shaped tool.

4. The method of claim 1 wherein said visual attribute comprises at least one of an icon, a name, a date, and a number representing the number of said duplicate items represented by said visual attribute.

5. The method of claim 1 further comprising displaying said list as a group view, wherein said visual attribute comprises: an author; and a number representing the number of said duplicate items represented by said visual attribute.

6. The method of claim 1 further comprising displaying said list as an expanded view, wherein said visual attribute comprises: an author, a subject/filename, a date, a status, and a type.

7. The method of claim 1 further comprising:
in response to user interaction with said visual attribute, displaying a preview of said common body portion; and
in response to user interaction with at least one of said duplicate items, displaying a preview of said common body portion.

8. A method of managing the on-screen display of duplicate items, said method comprising:
graphically representing a plurality of duplicate items within a list as a single on-screen item;
in response to user interaction with said single on-screen item, displaying said plurality of duplicate items next to said single on-screen item within said list; and
in response to user interaction, displaying said plurality of duplicate items within said list as said single on-screen item.

9. The method of claim 8 wherein said single on-screen item is an on-screen visual representation tool selected from the group consisting of a file name, an electronic mail message subject line, an electronic mail message sender, and an electronic mail message recipient.

10. The method of claim 8 wherein:
said single on-screen item comprises a chevron shaped tool,
said displaying said plurality of duplicate items after said single item is performed in response to user interaction with said chevron shaped tool, and
said displaying said plurality of duplicate items as said single item is performed in response to user interaction with said chevron shaped tool.

11. The method of claim 8 wherein said single on-screen item comprises at least one of an icon, a name, a date, and a number representing the number of said plurality duplicate items.

12. The method of claim 8 further comprising displaying said list as a group view, wherein said single on-screen item comprises: an author; and a number representing the number of said plurality duplicate items represented by said single on-screen item.

13. The method of claim 8 further comprising displaying said list as an expanded view, wherein said single on-screen item comprises: an author, a subject/filename, a date, a status, and a type.

14. The method of claim 8 further comprising, in response to user interaction with said single on-screen item, displaying a preview of said plurality of duplicate items.

15. A system comprising:
a processor;
a display;
memory coupled to the processor, wherein said memory comprises instructions that when executed cause said system to perform a method of visually displaying information on said display, said method comprising:
graphically displaying a stacked item tool within a list;
in response to user interaction with said stacked item tool, expanding said stacked item tool and displaying duplicate individual items within said stacked item tool as part of said list, wherein said duplicate individual items comprise a common body portion and different identifying information; and
in response to user interaction with said list, collapsing said duplicate individual items and displaying said duplicate individual items as said stacked item tool.

16. The system of claim 15 wherein:
said stacked item tool comprises a chevron shaped tool,
said expanding is performed in response to user interaction with said chevron shaped tool, and
said collapsing is performed in response to user interaction with said chevron shaped tool.

17. The system of claim 15 wherein said stacked item tool comprises at least one of an icon, a name, a date, and a number representing the number of said duplicate individual items represented by said stacked item tool.

18. The system of claim 15 wherein said method further comprises displaying said list as a group view, wherein said stacked item tool comprises: an author; and a number representing the number of said duplicate individual items represented by said stacked item tool.

19. The system of claim 15 wherein said method further comprises displaying said list as an expanded view, wherein said stacked item tool comprises: an author, a subject/filename, a date, a status, and a type.

20. The system of claim 15 wherein said method further comprises, in response to user interaction with at least one of said stacked item tool and said duplicate individual items, displaying said common body portion.
